(19) United States
(12) Patent Application Publication
(10) Pub. No.: US 2011/0134050 A1
(43) Pub. Date: Jun. 9, 2011

(54) FABRICATION OF TOUCH SENSOR PANEL USING LASER ABLATION

(76) Inventor: Jonah A. HARLEY, Mountain View, CA (US)

(21) Appl. No.: 12/642,466

(22) Filed: Dec. 18, 2009

Related U.S. Application Data
(60) Provisional application No. 61/267,346, filed on Dec. 7, 2009.

(51) Int. Cl. G06F 3/041; H01G 5/18

(52) U.S. Cl. 345/173; 29/25.42

(57) ABSTRACT

Fabrication of a touch sensor panel using laser ablation is disclosed. The fabricated touch sensor panel can have its touch sensors formed on an under surface of its cover substrate. A fabrication method can include depositing a conductive layer onto a substrate, depositing a dielectric material onto the conductive layer, ablating the conductive layer to define different regions for the touch sensors, and depositing a conductive material on the dielectric material. Another fabrication method can include sputtering a conductive material onto a substrate at discrete locations on the substrate, printing a dielectric material on the conductive material at the discrete locations, depositing a conductive layer over the substrate, and selectively ablating the conductive layer at the discrete locations to define different regions for the touch sensors. The touch sensor panel can be incorporated into a mobile telephone, a digital media player, or a personal computer.

### CROSS-REFERENCE TO RELATED APPLICATIONS

This application claims the benefit of U.S. Provisional Patent Application No. 61/267,346, filed on Dec. 7, 2009, the contents of which are incorporated herein in their entirety for all purposes.

### FIELD

This relates generally to touch sensor panels and, more particularly, to fabrication of a touch sensor panel using laser ablation.

### BACKGROUND

Touch sensor panels are increasingly used as input devices to a computing system. Generally, a touch sensor panel can include a cover substrate (formed from glass, polymer, or the like) to input information via touch and a sensor substrate (also formed from glass, polymer, or the like) with touch sensors to sense the touch on the cover substrate. In a drive to make a thinner touch sensor panel, it is desirable to eliminate the unwanted thickness of the sensor substrate. However, successfully providing a touch sensor panel without the sensor substrate has not been easy.

Elimination of the sensor substrate requires that the touch sensors be located on preferably another existing surface in the panel. The preferred surface has been the cover substrate. However, the cover substrate has not been a viable option for at least some of the following reasons. In some embodiments, the cover substrate is glass cut and shaped from a motherglass sheet. Then, for strength and durability, the cover glass is typically chemically strengthened with a strong ionic solution to strengthen all the glass surfaces, including the cut, shaped edges. Because chemical strengthening can damage the thin films of the touch sensors, it can be ineffective to place the touch sensors on the cover glass prior to strengthening. However, after the chemical strengthening has been completed, conventional touch sensor placement processes, such as photolithography and etching, which were developed for the larger motherglass sheets, can be either technically infeasible or too costly for the smaller cover glass (which is cut from the motherglass sheet). As a result, it can be difficult to use conventional placement processes to place the touch sensors on the cover glass after strengthening.

Accordingly, this approach to thinner touch sensor panels has been problematic.

### SUMMARY

This relates to fabrication of a touch sensor panel using laser ablation, in which the panel's touch sensors can be formed on an under surface of the panel's cover substrate. A fabrication method can include depositing a conductive layer onto a substrate, depositing a dielectric material onto the conductive layer, ablating the conductive layer to define different regions for touch sensors, and depositing a conductive material on the dielectric material. Another fabrication method can include sputtering a conductive material onto a substrate at discrete locations on the substrate, printing a dielectric material on the conductive material at the discrete locations, depositing a conductive layer over the substrate, and selectively ablating the conductive layer at the discrete locations to define different regions for touch sensors. These fabrication methods can advantageously provide touch sensors on an under surface of a cover substrate of a touch sensor panel, thereby resulting in a thinner panel.

### BRIEF DESCRIPTION OF THE DRAWINGS

FIGS. 1a and 1b illustrate a plan view and a cross-sectional view, respectively, of an exemplary touch sensor panel fabricated using laser ablation according to various embodiments.

FIG. 2 illustrates an exemplary method for fabricating a touch sensor panel using laser ablation according to various embodiments.

FIGS. 3a through 3f illustrate an exemplary touch sensor panel fabricated using laser ablation according to various embodiments.

FIG. 4 illustrates another exemplary method for fabricating a touch sensor panel using laser ablation according to various embodiments.

FIGS. 5a through 5g illustrate another exemplary touch sensor panel fabricated using laser ablation according to various embodiments.

FIG. 6 illustrates an exemplary mobile telephone having a touch sensor panel fabricated using laser ablation according to various embodiments.

FIG. 7 illustrates an exemplary digital media player having a touch sensor panel fabricated using laser ablation according to various embodiments.

FIG. 8 illustrates an exemplary personal computer having a touch sensitive display and a touchpad fabricated using laser ablation according to various embodiments.

### DETAILED DESCRIPTION

In the following description of various embodiments, reference is made to the accompanying drawings which form a part hereof, and in which it is shown by way of illustration specific embodiments which can be practiced. It is to be understood that other embodiments can be used and structural changes can be made without departing from the scope of the various embodiments.

This relates to fabrication of a touch sensor panel using laser ablation. The fabricated touch sensor panel can have touch sensors disposed on an under surface of a cover substrate. A fabrication method can include depositing a conductive layer onto a substrate, depositing a dielectric material onto the conductive layer, ablating the conductive layer to define different regions for the touch sensors, and depositing a conductive material on the dielectric material. Another fabrication method can include sputtering a conductive material onto a substrate at discrete locations on the substrate, printing a dielectric material on the conductive material at the discrete locations, depositing a conductive layer over the substrate, and selectively ablating the conductive layer at the discrete locations to define different regions for the touch sensors. These fabrication methods can advantageously provide touch sensors on an under surface of a cover substrate of a touch sensor panel, thereby resulting in a thinner panel.

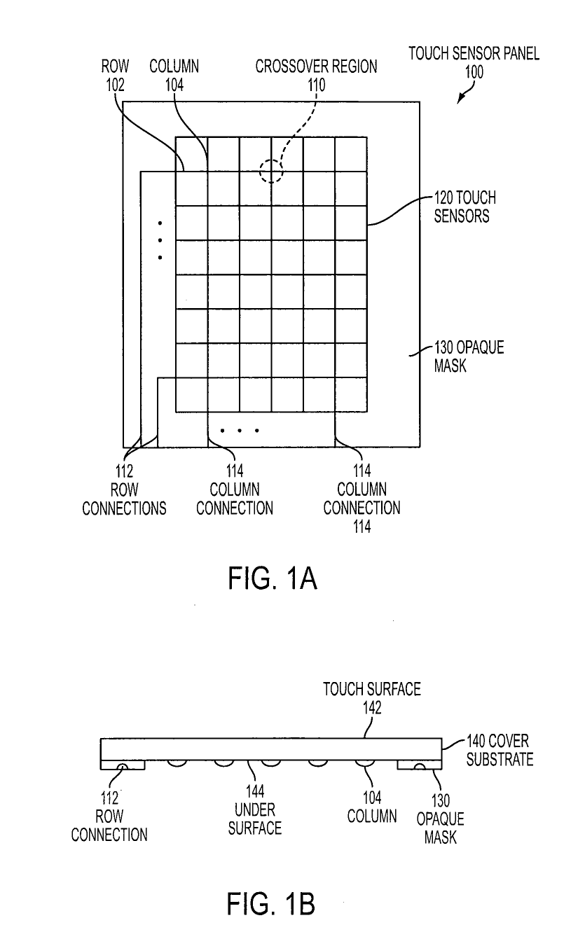

FIGS. 1a and 1b illustrate a plan view and a cross-sectional view, respectively, of an exemplary touch sensor panel fabricated using laser ablation according to various embodiments. In the examples of FIGS. 1a and 1b, touch sensor panel 100 can include cover substrate 140 having touch surface 142 for touching by an object, such as a user's finger, a stylus, and the like. The touch sensor panel 100 can also include touch sensors 120 disposed on under surface 144 of the cover substrate 140 (a surface opposite the touch surface 142) for sensing a touch on the touch surface 142. Rows 102 and columns 104 of conductive traces can form the touch sensors 120 around crossover regions 110 of the traces. The touch sensor panel 100 can also include opaque mask 130 disposed on the under surface 144 of the cover substrate 140 for providing an aesthetic border to hide underlying circuitry. In some embodiments, the opaque mask 130 can be conductive and can form row connections 112 and column connections 114 for electrically connecting the touch sensors 120 to other sensing circuitry (not shown). In other embodiments, the opaque mask 130 can be non-conductive and can have conductive traces forming the row connections 112 and column connections 114 disposed thereon. The touch sensors 120, opaque mask 130, and connectors 112 and 114 can be formed on the cover substrate 140 using laser ablation and printing, such as ink-jet printing or screen printing, for example, which will be described in more detail below.

It is to be understood that the touch sensors 120 are not limited to a row-column arrangement illustrated here, but can include radial, circular, diamond, and other arrangements capable of sensing a touch.

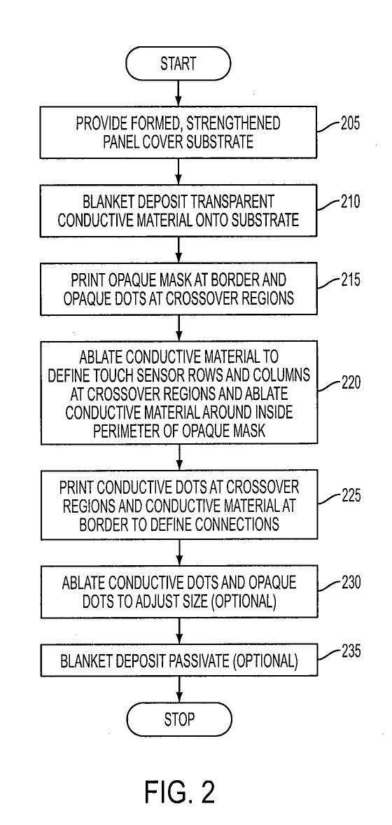

FIG. 2 illustrates an exemplary method for fabricating a touch sensor panel using laser ablation according to various embodiments. In the example of FIG. 2, a cover substrate having been strengthened and formed into a desired shape for a touch sensor panel can be provided (205). The cover substrate can be glass, polymer, or some other suitable substrate, for example. A transparent conductive layer can be deposited on the under surface of the cover substrate to blanket the under surface, where the under surface can be opposite the cover substrate touch surface (210). The conductive layer can be deposited using a sputtering technique, for example. The conductive layer can be indium-tin-oxide (ITO) or some other suitable conductive material, for example. An opaque dielectric material can be printed onto the conductive layer around the border of the cover substrate to form an opaque mask and can be printed onto the conductive layer at crossover regions in a center portion of the cover substrate to form discrete opaque dots (215). The crossover regions can refer to regions on the cover substrate where touch sensor rows and columns can be formed to cross over each other and remain electrically isolated from each other. The opaque material can be printed at the border and the crossover regions either in a single operation or in separate sequential operations.

A laser can ablate the conductive layer in the center portion to define rows and columns for touch sensors (220). The laser can remove some of the conductive layer to create gaps separating and electrically isolating the rows and columns from each other. The laser can also remove portions of the opaque dots printed at the conductive layer removal locations. The gaps can be patterned to divide the conductive layer into essentially horizontal discontinuous regions (forming rows) and essentially vertical continuous regions (forming columns), where the horizontal row regions are bisected by the vertical column regions. The locations where the horizontal row regions are bisected by the vertical column regions can be the crossover regions at which touch sensors can form. The discontinuous row regions can be electrically connected together at the crossover regions to form electrically continuous rows, as will be described below. Other patterns of the conductive layer are also possible according to the desired touch sensor arrangement. For example, the row regions can be continuous and the column regions can be discontinuous and bisected by the row regions.

The laser can also ablate the conductive layer around the inside perimeter of the opaque mask at the border (220). The laser can remove some of the conductive layer to create a perimeter gap separating and electrically isolating the rows and columns from the conductive layer at the border.

A print device can print dots of a second conductive material on the conductive layer and the opaque dots at the crossover regions to bridge the discontinuous row regions, thereby electrically connecting these regions in rows (225). The print device can also print traces of the second conductive material onto the opaque mask at the border to define connections to the rows and columns (225). The second conductive material can be printed at the border and the crossover regions either in a single operation or in separate sequential operations. The second conductive material can be silver ink, ITO, or some other suitable conductive material, for example. The print device can utilize ink-jet printing, screen printing, or other suitable printing techniques. The touch sensors in the crossover regions can now be considered formed, with conductive column regions, conductive row regions connected together with conductive dots and crossing over the conductive column regions, and opaque dielectric dots between the row and column regions to ensure that they are electrically isolated from each other.

In some circumstances, the print device can be imprecise, resulting in dots that are larger than needed and that are also visible through the cover substrate. Optionally, the conductive and opaque dots' sizes can be adjusted (230). The laser can ablate the opaque dots and the conductive dots in the crossover regions to remove portions thereof, thereby reducing the size and visibility of the dots.

A passivation layer can optionally be deposited to cover all the components on the cover substrate under surface, including the touch sensors and the opaque mask, except a small portion of the opaque mask at the border (235). The passivation layer can be a transparent dielectric or some other suitable material, for example. The small portion of the mask at the border can expose the ends of the row and column connections for connecting to other sensing circuitry, such as a flex circuit, for example. The passivation layer can protect the cover substrate components from corrosion.

In an alternate embodiment, rather than printing traces of the second conductive material at the border to define connections to the rows and columns (225), a single wide trace of the second conductive material can be printed at the border and can be ablated to create gaps separating and electrically isolating portions of the material from each other, where the portions can be the connections. The gaps can be patterned so that defined connections can be aligned with corresponding rows and columns in the center portion. If the ablation also removes portions of the underlying opaque mask, a second opaque dielectric material can be printed in the gaps to prevent light underneath the cover substrate from leaking through.

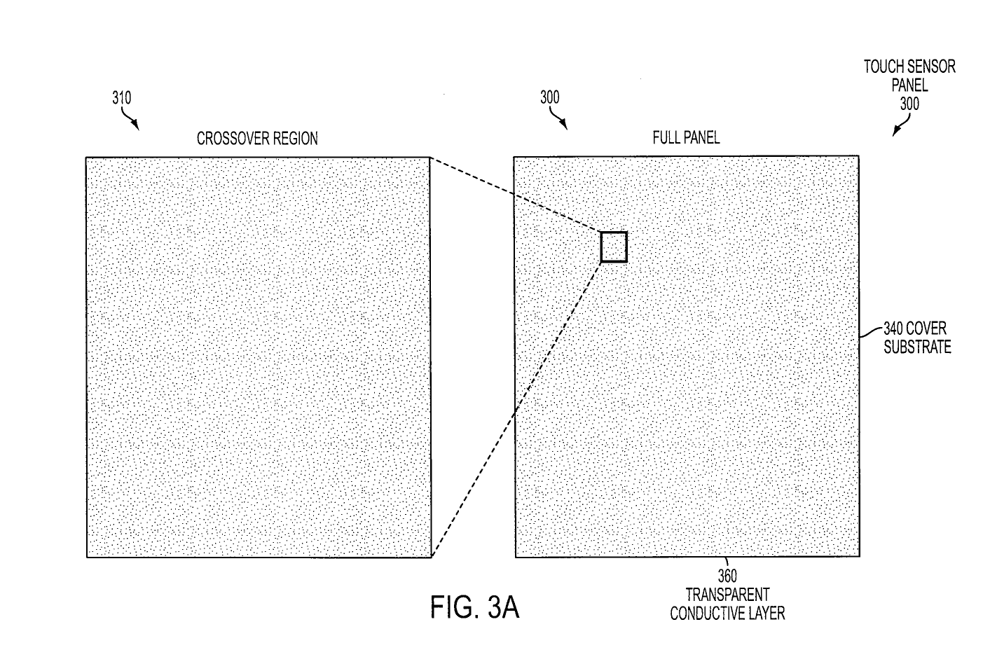

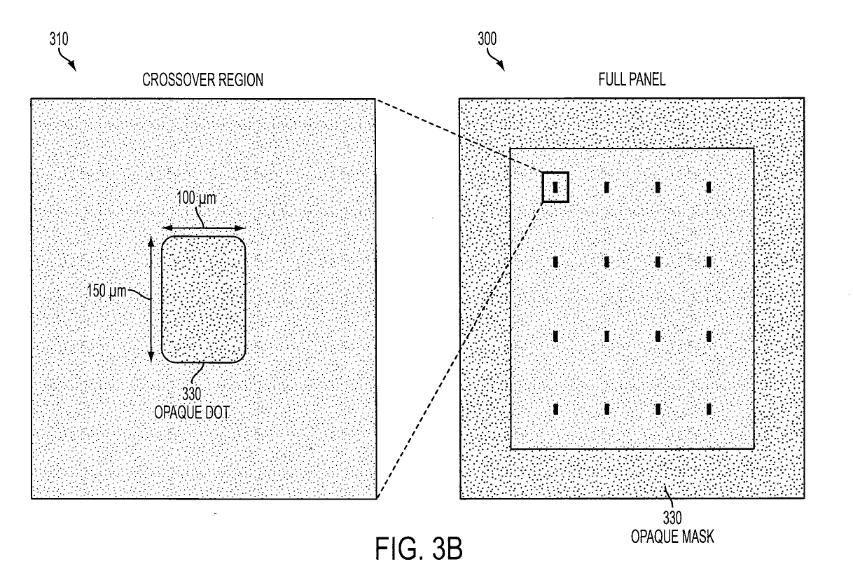

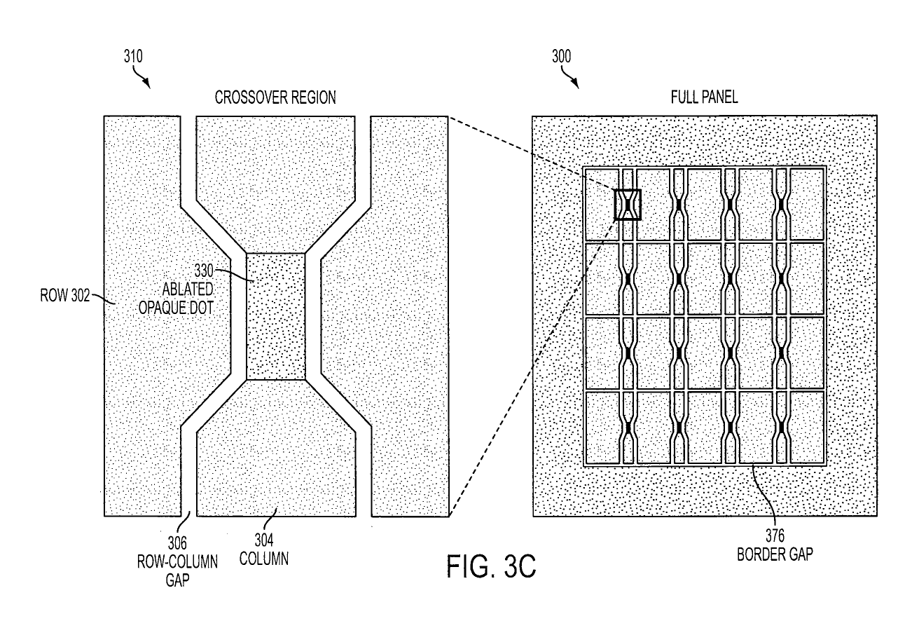

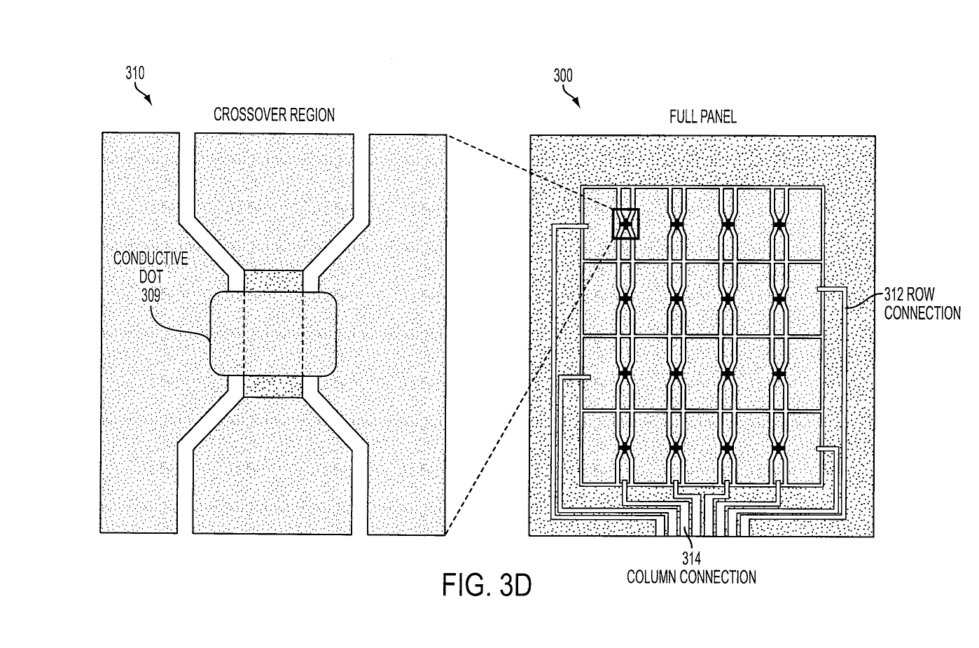

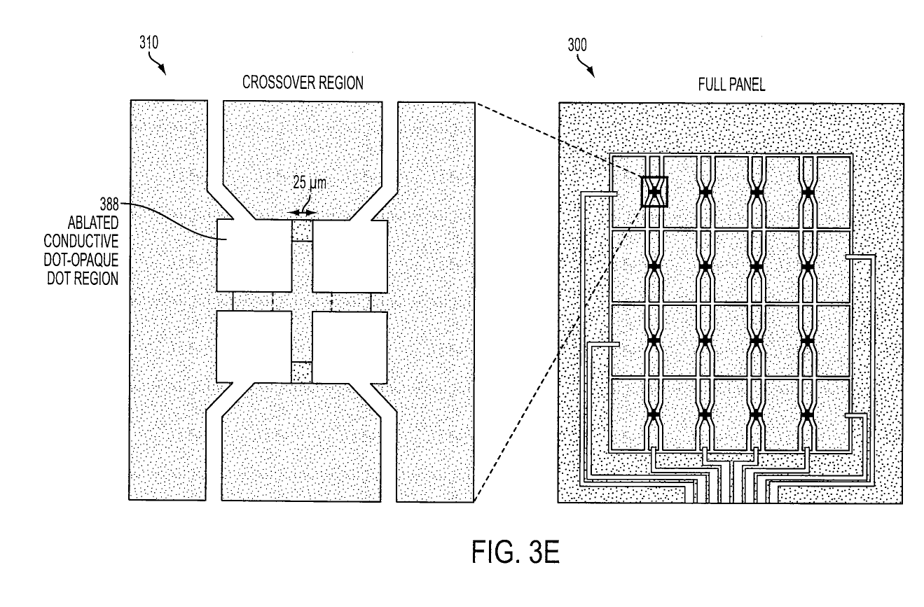

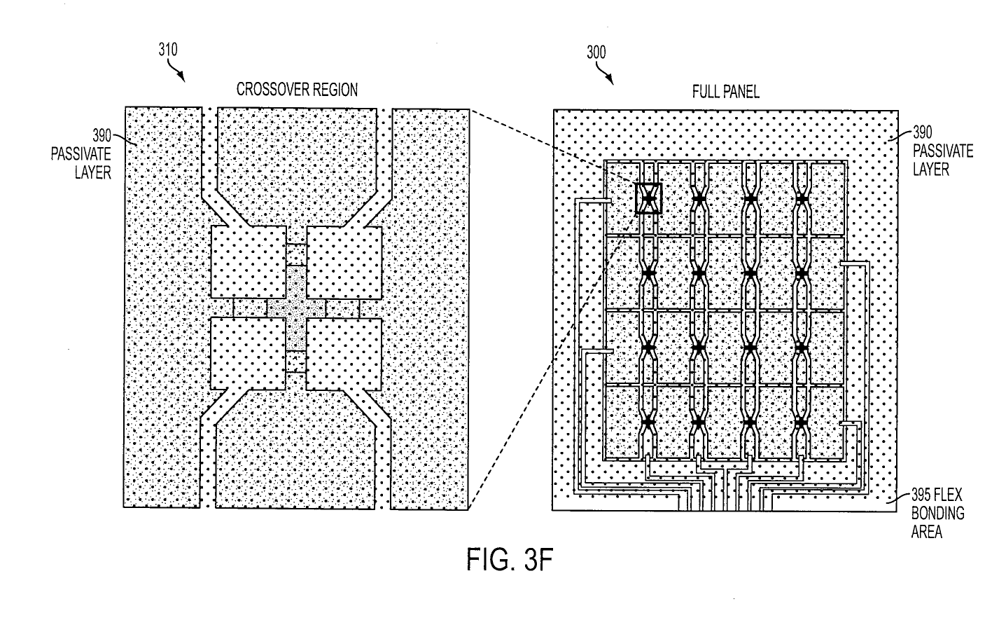

FIGS. 3a through 3f illustrate an exemplary touch sensor panel fabricated according to the method of FIG. 2. In the example of FIG. 3a, touch sensor panel 300 can include cover substrate 340 having transparent conductive layer 360 covering an under surface of the substrate opposite the touch surface. Crossover region 310 can include the transparent conductive layer 360. In the example of FIG. 3b, opaque dielectric material can be printed on the conductive layer 360 around the border of the cover substrate to form opaque mask 330. The opaque dielectric material can also be printed on the conductive layer 360 at crossover regions to form opaque dots 330. The crossover region 310 illustrates the opaque dielectric dot 330 disposed on the conductive layer 360. In some embodiments, the dot 330 can have a size of about 100 μm by 150 μm. In the example of FIG. 3c, the conductive layer 360 in a center portion of the cover substrate can be ablated to define rows 302 and columns 304 of touch sensors, where the rows and columns are separated and electrically isolated by gaps 306. The crossover region 310 illustrates the column 304, which forms a continuous vertical region of the conductive layer with the ablated opaque dot 330 disposed thereon, the row 302, which forms two adjacent discontinuous horizontal regions of the conductive layer, and the gap 306, which electrically isolates the row and column from each other. The conductive layer 360 at the inside perimeter of the opaque mask 330 in a border portion of the cover substrate can also be ablated to form border gap 376.

In the example of FIG. 3d, dots of conductive material 309 can be printed in the crossover regions 310. The crossover region 310 illustrates the conductive dot 309 covering portions of the opaque dot 330 and contacting the two adjacent regions forming the row 302. As such, the conductive dot 309 can bridge the two regions to electrically connect them together to form the row 302 crossing over the column 304, with the ablated opaque dot 330 separating the row and column. In some embodiments, the conductive dot 309 can have a size of about 100 μm by 150 μm. Traces of the conductive material can also be printed on the opaque mask at the border to define row connections 312 and column connections 314. The row connections 312 can connect the rows 302 and the column connections 314 can connect the columns 304 to other sensing circuitry.

In the example of FIG. 3e, the conductive dots 309 and the opaque dots 330 in the crossover regions 310 can be ablated to remove any regions 388 that are too large and/or visible through the cover substrate, while still providing the electrical connection between the row regions and the separation between the row and column. In some embodiments, the dots 309 and 330 can be reduced in width to about 25 μm. In the example of FIG. 3f, passivation layer 390 can cover the components, except for a portion of the border that can be used for connecting to other sensing circuitry, e.g., the portion can be used as a bonding area 395 to bond the row and column connections 312 and 314 to a flex circuit (not shown).

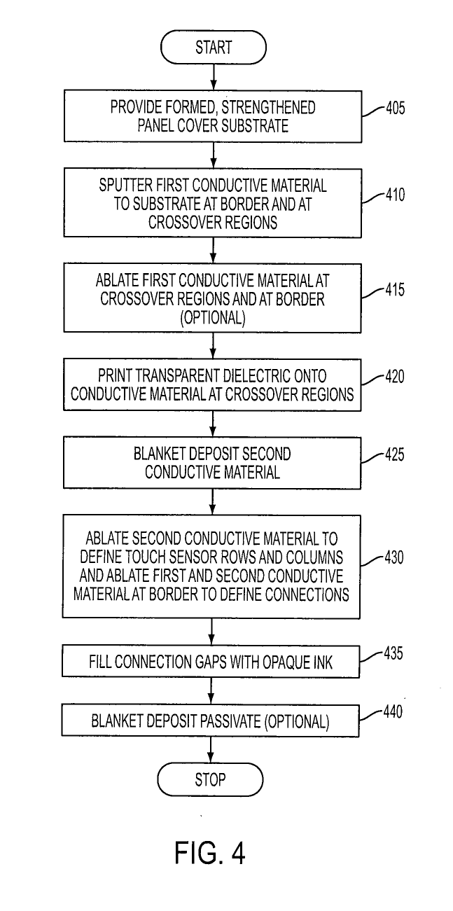

FIG. 4 illustrates another exemplary method for fabricating a touch sensor panel using laser ablation according to various embodiments. In the example of FIG. 4, a cover substrate having been strengthened and formed into a desired shape for a touch sensor panel can be provided (405). The cover substrate can be glass, polymer, or some other suitable substrate, for example. A first conductive material can be sputtered onto an under surface of the cover substrate around the border of the cover substrate and at crossover regions in a center portion of the cover substrate to form discrete conductive dots (410). The first conductive material can be an opaque material such as black chrome or some other suitable opaque conductive material or stack of materials, for example. Alternatively, the first conductive material can be a transparent material such as ITO or some other suitable transparent conductive material or stack of materials, for example. The crossover regions as described previously can be regions where rows and columns of conductive traces cross to form touch sensors. A shadow mask or a print screen can be used during the sputtering to cover a center portion of the cover substrate, except discrete areas corresponding to the crossover regions, and to expose a border portion of the cover substrate and the discrete areas to the sputtered conductive material. If the conductive material is opaque, the conductive material can serve as a mask at the border.

Sputtering can result in a deposition with coarsely defined edges, sizes, and/or shapes. As such, optionally, a laser can ablate the sputtered conductive material to sharpen the edges at the border (if opaque) and to reduce the size of the discrete conductive dots (if opaque) to make them less visible through the cover substrate (415).

A print device can print dots of a transparent dielectric material on the conductive dots at the crossover regions (420). The print device can utilize ink-jet printing, screen printing, or some other suitable printing techniques. The dielectric dots can be printed to cover part but not all of the conductive dots. The uncovered portions of the conductive dots can be used as will be described in more detail below.

A second conductive material can be deposited over the under surface of the cover substrate to blanket the under surface, including covering the first conductive material and the transparent dielectric material (425). The second conductive material can be ITO or some other suitable conductive material, for example. A laser can ablate the second conductive material in the center portion to define rows and columns for touch sensors by removing some of the conductive material to create gaps separating and electrically isolating the rows and columns (430). The gaps can be patterned to create the rows and columns, as previously described. For example, the rows can be continuous horizontal regions and the columns can be discontinuous vertical regions bisected by the horizontal row regions. The laser wavelength, pulse duration, power, and the like can be tuned so that it selectively ablates the second conductive material, but stops on either the underlying dielectric dots or the underlying conductive dots. The touch sensors in the crossover regions can now be considered formed, with conductive column regions connected together with the uncovered portions of the conductive dots on the cover substrate, conductive row regions crossing over the conductive column regions, and transparent dielectric between the row and column regions to ensure that they are electrically isolated from each other.

The laser can also ablate the second conductive material and the first conductive material in the border portion to define connections to the rows and columns (430). The laser can remove some of the first and second conductive material to create gaps separating and electrically isolating the connections (415). The gaps can be patterned so that the defined connections can be aligned with corresponding rows and columns in the center portion.

The print device can print opaque ink on the gaps between the connections in the border region to prevent light underneath the cover substrate from leaking through (435). If the first conductive material is transparent, the print device can print the opaque ink on the entire border portion to form an opaque mask.

Optionally, a passivation layer can be deposited to cover all the components on the cover substrate, including the touch sensors and the connections, except a small portion at the border (440). The small portion can expose the ends of the row and column connections for connecting to other sensing circuitry, such as a flex circuit, for example. The passivation layer can protect the cover substrate components from corrosion.

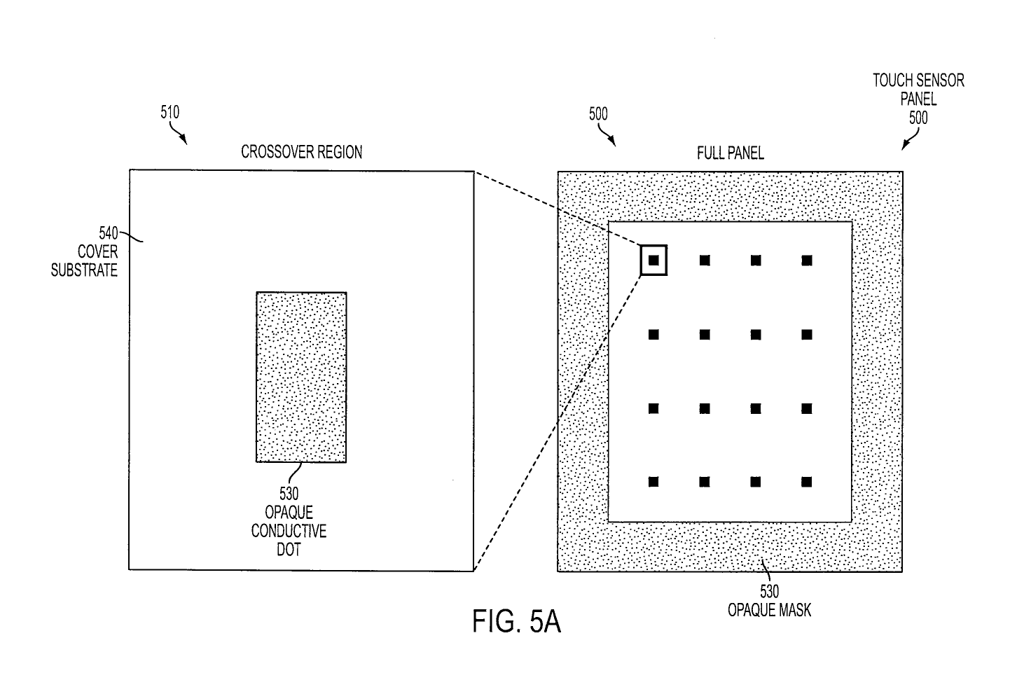

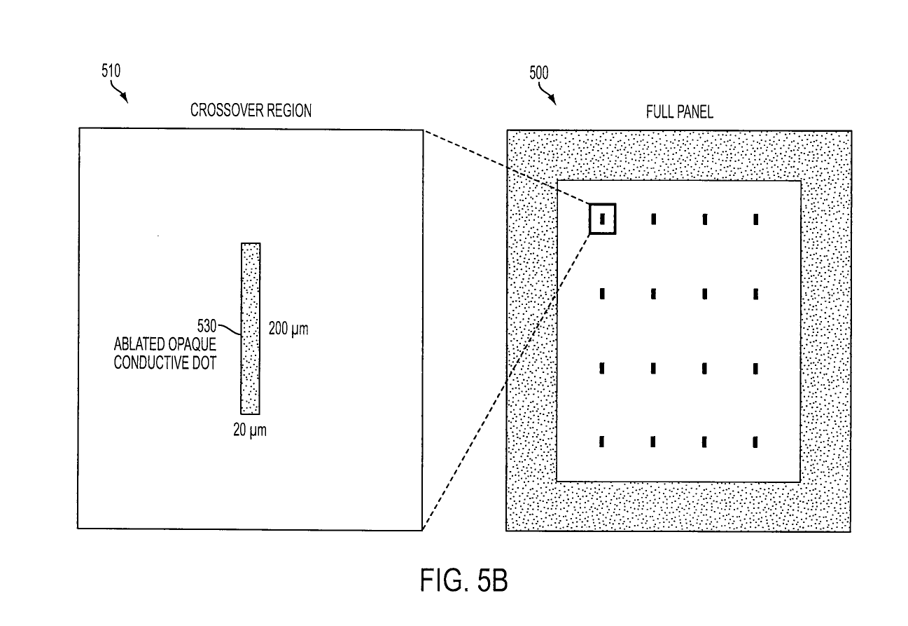

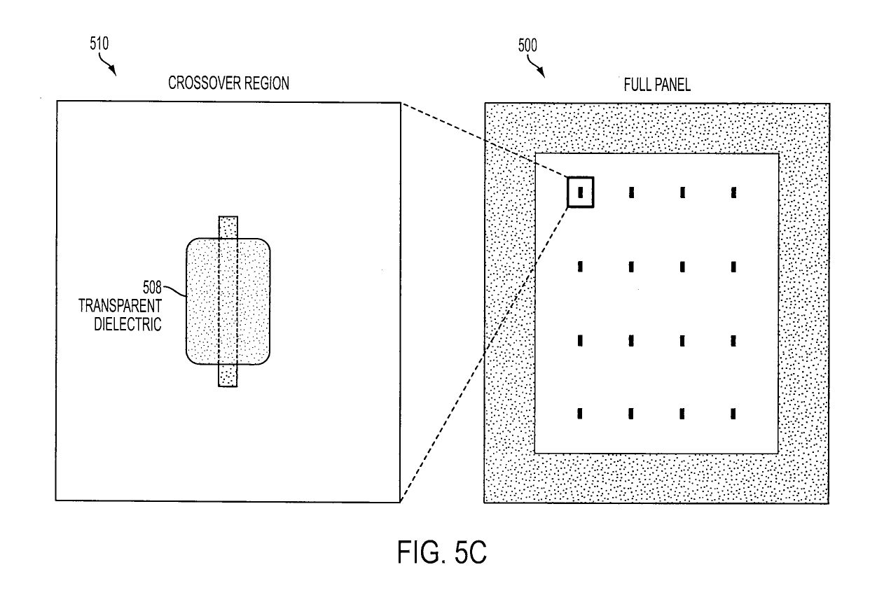

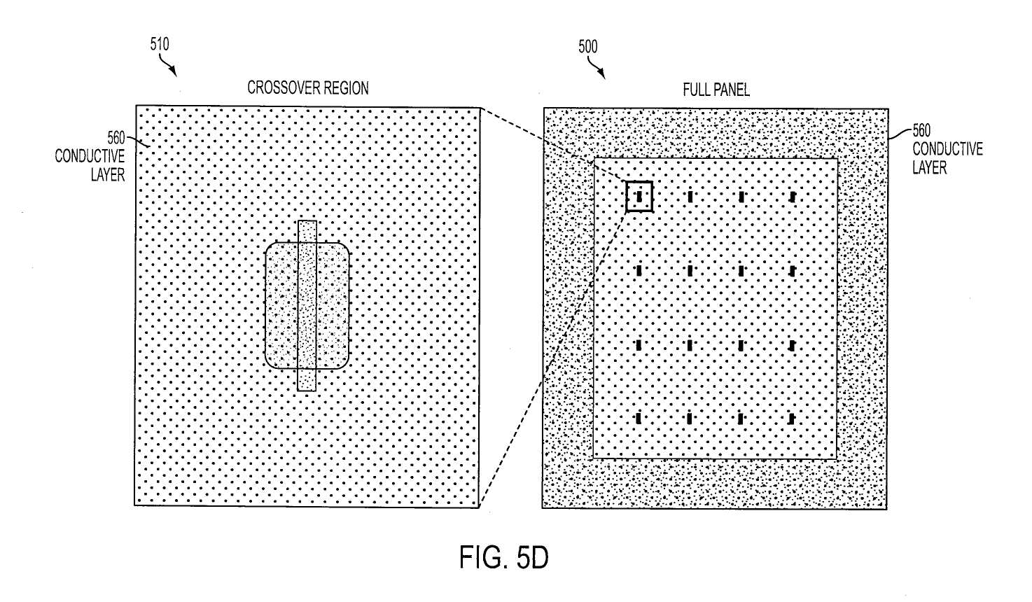

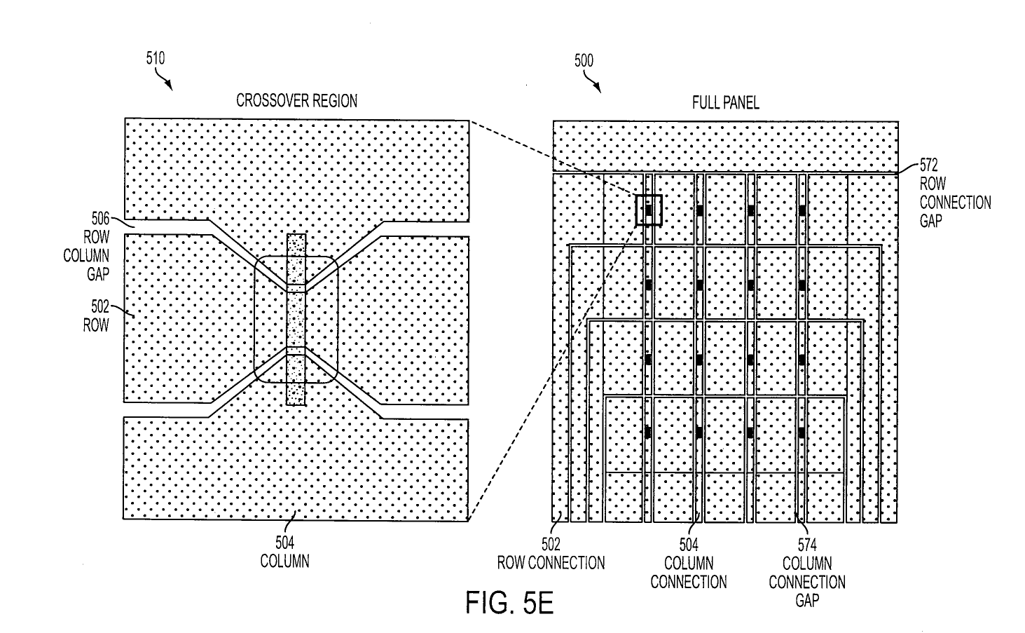

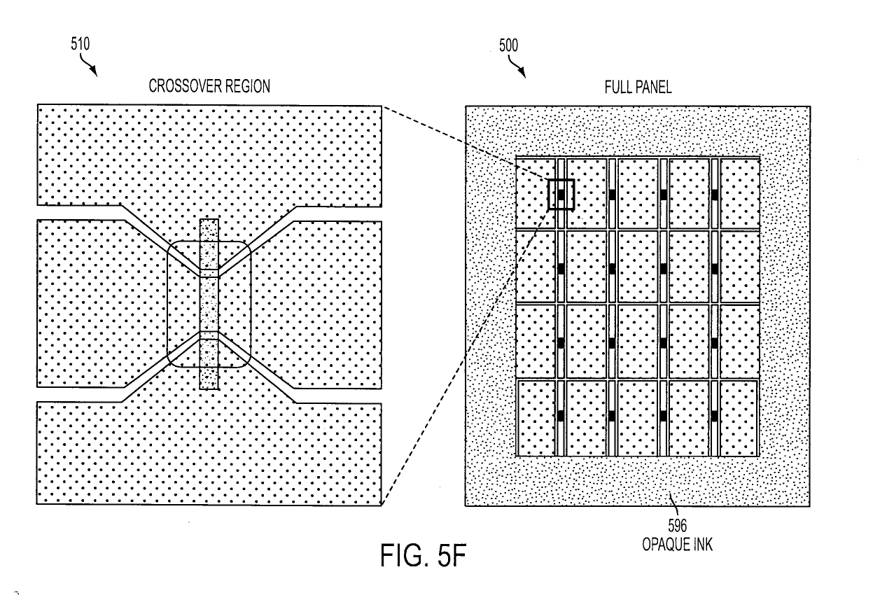

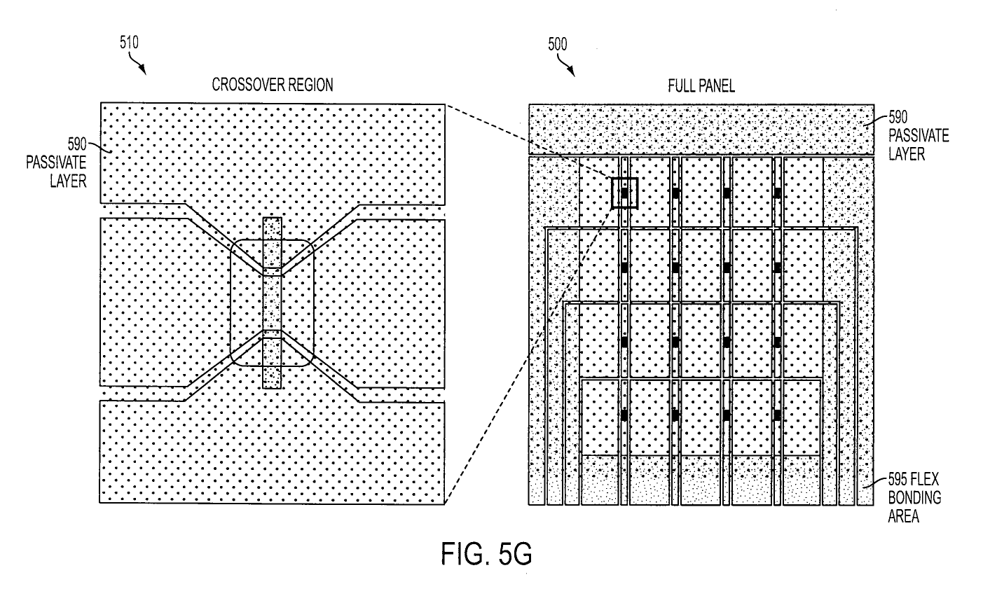

FIGS. 5a through 5g illustrate an exemplary touch sensor panel fabricated according to the method of FIG. 4. In the example of FIG. 5a, touch sensor panel 500 can include cover substrate 540 having opaque conductive material 530 sputtered on an under surface around a border of the cover substrate to form an opaque mask and at crossover regions 510 on the cover substrate to form discrete dots. The crossover region 510 can include a dot of the opaque conductive material 530. In the example of FIG. 5b, the opaque conductive dots 530 in the crossover regions 510 can be ablated to be thinner and less visible through the cover substrate 540. In some embodiments, the dots 530 can have an ablated size of about 20 μm by 200 μm. In the example of FIG. 5c, dots of transparent dielectric material 508 can be printed on the opaque conductive dots 530 in the crossover regions 510. In the example of FIG. 5d, conductive layer 560 can be deposited over the entire cover substrate 540, including the opaque conductive dots 530, the opaque mask 530, and the transparent dielectric dots 508.

In the example of FIG. 5e, the conductive layer 560 in a center portion of the cover substrate 540 can be ablated to define rows 502 and columns 504 of touch sensors, where the rows and columns are separated and electrically isolated by gaps 506. The crossover region 510 illustrates the row 502, which forms a continuous horizontal region of the conductive layer, the column 504, which forms two adjacent discontinuous vertical regions of the conductive layer, and the gap 506, which electrically isolates the row and column from each other. The opaque conductive dot 530 can bridge the two vertical regions to electrically connect them together to form the column 504 crossing under the row 502, with the dielectric dot 508 separating the row and column. The opaque mask 530 and the conductive layer 560 in a border portion of the cover substrate 540 can also be ablated to define row connections 512 and column connections 514 to the rows 502 and columns 504, where the connections are separated and electrically isolated by respective gaps 572 and 574. In the example of FIG. 5f, opaque ink 596 can be printed on the gaps 572 and 574 in the border portion of the cover substrate 540.

In the example of FIG. 5g, passivation layer 590 can cover the cover substrate components, except for a portion of the border that can be used for connecting to other sensing circuitry, e.g., the portion can be used as a bonding area 595 for a flex circuit (not shown).

In alternate embodiments, rather than using an opaque conductive material 530 as illustrated in FIGS. 5a through 5g, a transparent conductive material can be used. As such, the conductive dots 530 need not be ablated to make them less visible through the cover substrate (as in FIG. 5b) and the opaque ink 596 can be deposited around the entire border to form the opaque mask (as in FIG. 5f).

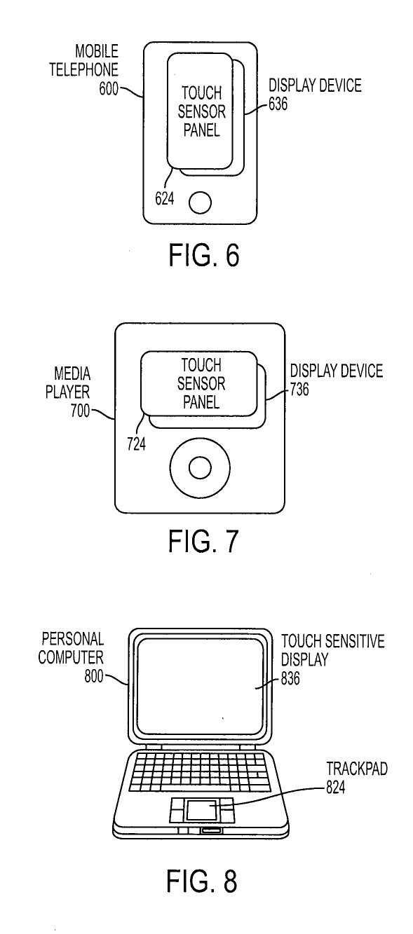

FIG. 6 illustrates an exemplary mobile telephone 600 that can include a display 636 and a touch sensor panel 624 fabricated using laser ablation according to various embodiments.

FIG. 7 illustrates an exemplary digital media player 700 that can include a display 736 and a touch sensor panel 724 fabricated using laser ablation according to various embodiments.

FIG. 8 illustrates an exemplary personal computer 800 that can include a touch sensitive display 836 and a touch sensor panel (trackpad) 824, where the touch sensitive display and the trackpad can be fabricated using laser ablation according to various embodiments.

The mobile telephone, media player, and personal computer of FIGS. 6 through 8 can be thinner with a touch sensor panel fabricated according to various embodiments.

Although embodiments describe touch sensors, it is to be understood that proximity and other types of sensors can also be used.

Although embodiments describe the touch sensors being formed on a single side of a strengthened, formed cover substrate, it is to be understood that the touch sensors or portions thereof can be formed on multiple sides of the cover substrate or some other suitable substrate ready for use in a touch sensor panel.

Although embodiments have been fully described with reference to the accompanying drawings, it is to be noted that various changes and modifications will become apparent to those skilled in the art. Such changes and modifications are to be understood as being included within the scope of the various embodiments as defined by the appended claims.

What is claimed is:

1. A method comprising:
depositing a conductive layer onto a substrate;
depositing dielectric material onto the conductive layer;
ablating the conductive layer to define different regions of touch sensors; and
depositing a conductive material on the dielectric material.

2. The method of claim 1, wherein ablating the conductive layer comprises removing portions of the conductive layer to form gaps between the different regions.

3. The method of claim 1, wherein the different regions comprise rows and columns, the rows and columns being electrically isolated from each other, the rows having discontinuities therein and having contact with the conductive material to bridge the discontinuities.

4. The method of claim 1, wherein depositing the dielectric material comprises forming electrical insulators between the different regions.

5. The method of claim 1, wherein depositing the conductive material comprises forming electrical conductors between the different regions.

6. The method of claim 1, comprising ablating the dielectric material and the conductive material to reduce visibility of the dielectric material and the conductive material.

7. The method of claim 1, wherein the touch sensors are configured to sense a touch on a surface of the substrate that is opposite a surface with the conductive layer, the dielectric material, and the conductive material disposed thereon.

8. A method comprising:
depositing a conductive material onto a substrate at discrete locations on the substrate;
printing a dielectric material on the conductive material at the discrete locations;
depositing a conductive layer over the substrate; and
selectively ablating the conductive layer at the discrete locations to define different regions of touch sensors.

9. The method of claim 8, comprising ablating the deposited conductive material to remove portions of the conductive material and reduce a size thereof, wherein the conductive material is either transparent or opaque.

10. The method of claim 8, wherein printing the dielectric material comprises printing an electrical insulator between the conductive material and the conductive layer.

11. The method of claim 8, wherein selectively ablating the conductive layer comprises removing portions of the conductive layer to form gaps between the different regions without removing at least some of the underlying dielectric material and conductive material.

12. The method of claim 8, wherein the different regions comprise rows and columns, the rows and columns being electrically isolated from each other, the columns having discontinuities therein at the discrete locations and having contact with the conductive material to bridge the discontinuities.

13. The method of claim 8, wherein the deposited conductive material is configured to electrically connect at least some of the different regions.

14. The method of claim 8, comprising depositing a passivation layer on the conductive layer.

15. A method comprising:
depositing a first material onto a substrate;
depositing a second material onto the substrate;
ablating at least some of the deposited second material to define touch sensors; and
associating at least some of the deposited first material with connections to the touch sensors.

16. The method of claim 15, wherein:
depositing the first material comprises depositing at least some of the first material around a border of the substrate, the first material being conductive and opaque, and
depositing the second material comprises depositing at least some of the second material around the border of the substrate, the second material being conductive and transparent, the method comprising:
ablating the deposited second material and the deposited first material around the border of the substrate to define the connections to the touch sensors.

17. The method of claim 15, wherein depositing the first material comprises depositing at least some of the first material around a border of the substrate, the first material being dielectric and opaque, the method comprising:
depositing a third material onto the deposited first material around the border of the substrate, the third material being conductive; and
ablating the deposited third material to define the connections to the touch sensors.

18. The method of claim 17, comprising:
ablating at least some of the deposited first material around the border of the substrate during the ablating of the deposited third material; and
depositing a fourth material into gaps formed by the ablating of the deposited first material, the fourth material being dielectric and opaque.

19. A touch sensor panel comprising:
a cover substrate having a touchable surface;
multiple touch sensors formed on a surface of the cover substrate opposite the touchable surface, the touch sensors having been formed by ablating and printing at least one of conductive material or dielectric material; and
multiple connections formed on the surface of the cover substrate opposite the touchable surface to connect to the touch sensors, the connections having been formed by ablating and printing at least one of the conductive material or the dielectric material.

20. The panel of claim 19, wherein the ablating comprises laser ablating.

21. The panel of claim 19, wherein the printing comprises ink-jet printing or screen printing.

22. The panel of claim 19 incorporated into at least one of a mobile telephone, a digital media player, or a personal computer.

23. A structure comprising:
a substrate having been strengthened and formed into a shape;
a conductive pattern formed on a first surface of the substrate into touch sensors, the conductive pattern having been ablated and printed onto the first surface; and
a masking pattern formed on the first surface of the substrate in contact with the conductive pattern, the masking pattern having been ablated and printed onto the first surface.

24. The structure of claim 23, comprising:
another conductive pattern formed on a second surface of the substrate, the other conductive pattern having been ablated and printed onto the second surface,
wherein the second surface is opposite the first surface.

25. The structure of claim 23, wherein the conductive pattern forms a diamond pattern for the touch sensors.
